(19) United States
(12) Patent Application Publication
(10) Pub. No.: US 2018/0113699 A1
(43) Pub. Date: Apr. 26, 2018

(54) Automatically Installing Applications Based on Content Selection

(71) Applicant: Apple Inc., Cupertino, CA (US)

(72) Inventors: Derek A. Hunter, Aptos, CA (US); Lucas C. Newman, San Francisco, CA (US)

(21) Appl. No.: 15/693,156

(22) Filed: Aug. 31, 2017

Related U.S. Application Data
(60) Provisional application No. 62/413,414, filed on Oct. 26, 2016.

(51) Int. Cl. G06F 9/445

(52) U.S. Cl. CPC G06F 8/61; G06F 3/0482

(57) ABSTRACT

In some implementations, a system can automatically initiate installation of a content provider application based on a content selection by a user. For example, a user device can present a graphical user interface (GUI) of a watch list application on a display of the user device. The watch list application can present content item suggestions based on subscriptions or purchases that entitle the user to consume media content from various content providers. The user can select a suggested content item provided by a content provider from the watch list application. In response to the user selection, the watch list application can determine that a media content provider application corresponding to the content provider is not installed on the user device and automatically initiate installation of the media content provider application.

### RELATED APPLICATION

This application claims priority to U.S. Provisional Application No. 62/413,414, filed on Oct. 26, 2016, the content of which is incorporated herein by reference in its entirety.

### TECHNICAL FIELD

The disclosure generally relates to installing applications on computing devices.

### BACKGROUND

Traditional mechanisms (e.g., broadcast television, cable television, etc.) for viewing media content are becoming less and less popular. More and more people are turning to internet content providers to view media content. Media content providers often create software applications that viewers (e.g., users) can install on their computing devices and use to view media content provided by the corresponding media content provider. However, because modern users typically have several computing devices (e.g., smart phone, tablet computer, laptop computer, streaming media device, etc.), the user may wish to initiate viewing a media content item on a first computing device and continue watching the media content item on a second computing device. When the media content provider application is not installed on the second computing device, the user is required to waste time finding the media content provider application online, waste time installing the media content provider application on the second device, and waste time finding and selecting the media item in the media content provider application. Thus, a more streamlined and less burdensome mechanism for installing media content provider applications and initiating playback of media items may be desirable.

### SUMMARY

In some implementations, a system can automatically initiate installation of a content provider application based on a content selection by a user. For example, a user device can present a graphical user interface (GUI) of a watch list application on a display of the user device. The watch list application can present content item suggestions based on subscriptions or purchases that entitle the user to consume media content from various content providers. The user can select a suggested content item provided by a content provider from the watch list application. In response to the user selection, the watch list application can determine that a media content provider application corresponding to the content provider is not installed on the user device and automatically initiate installation of the media content provider application.

Particular implementations provide at least the following advantages. The user device can present content item suggestions based on the user's entitlements (e.g., subscriptions) even though the corresponding content provider application is not installed on the user device. The user is not required to search for a content provider application to install when the user wishes to view content associated with a content provider application that is not currently installed on the user device. The user can view and select content items from different content providers in a single graphical user interface.

Details of one or more implementations are set forth in the accompanying drawings and the description below. Other features, aspects, and potential advantages will be apparent from the description and drawings, and from the claims.

### DESCRIPTION OF DRAWINGS

FIG. 1 is a block diagram of an example system 100 for automatically installing applications based on content selection.

FIG. 2 illustrates an example graphical user interface 200 for presenting media content item recommendations.

FIG. 3 illustrates an example graphical user interface 300 for prompting the user to install a missing content provider application.

FIG. 4 illustrates an example graphical user interface 400 for presenting the status of a content provider application download process.

FIG. 5 illustrates an example graphical user interface 500 presenting options for selecting a media content provider application.

FIG. 6 illustrates an example graphical user interface 600 of a content provider application.

FIG. 7 is flow diagram of an example process 700 for automatically installing content provider applications based on content selection.

FIG. 8 is a block diagram of an example computing device 800 that can implement the features and processes of FIGS. 1-7.

Like reference symbols in the various drawings indicate like elements.

### DETAILED DESCRIPTION

### Overview

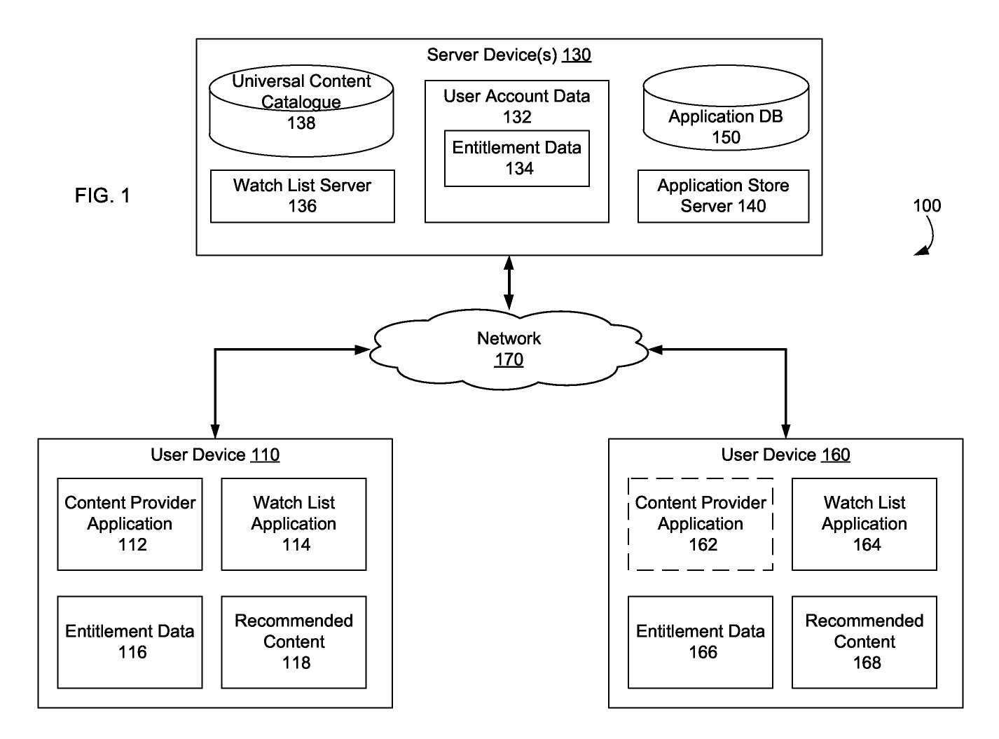

FIG. 1 is a block diagram of an example system 100 for automatically installing applications based on content selection. For example, system 100 can provide content item suggestions to a user based on the user's subscriptions (e.g., entitlements) to content (e.g., media, music, movies, videos, talk shows, etc.) provided by various content providers. A content item suggestion can be presented to the user even though the user device does not have a corresponding content provider application installed on the user device. When the user select the suggested content item, system 100 can automatically install the missing content provider application on the user device and automatically initiate playback of the selected content item in the newly installed content provider application.

In some implementations, system 100 can include user device 110. For example, user device 110 can be a laptop computer, smartphone, tablet computer, wearable device, set-top box, or other type of computing device. The user of user device 110 can interact with user device to view media content items (e.g., movies, television shows, live sporting events, music, etc.) provided by various media content providers.

In some implementations, user device 110 can include content provider application 112. For example, the user can provide input to user device 110 to cause user device 110 to download and/or install a content provider application 112 for each media content provider from which the user wishes to receive media content. Thus, user device 110 may include several content provider applications 112 corresponding to different content providers. The media content provider can operate a media content server (not shown) that is accessible by content provider application 112 through network 170. When the user selects a media content item through a user interface of content provider application 112, the media content server can send or stream the selected media content (e.g., prerecorded content, live content, etc.) to content provider application 112. Content provider application 112 can present the media content received from the media content server on a display of user device 110.

In some implementations, user device 110 can store entitlement data 116. For example, some media content providers require a user pay for media content provided by the media content provider. The user can pay for a subscription to a media content provider that entitles the user to receive media content from the media content provider. The user may have several subscriptions that entitle the user to consume media content from several different media content providers. User device 110 can obtain and store information describing the user's entitlements associated with various media content providers in entitlement data 116. For example, entitlement data 116 can include identifiers for each media content provider to which the user has an active subscription.

In some implementations, user device 110 can receive entitlement data 116 from a server device (e.g., server device 130) in communication with user device 110 through network 170. For example, the user can have a user account with a cloud service, application store, media store, or other service running on a server device (e.g., server device 130), as described below. The user can enter the authentication credentials (e.g., user name and password) for the user account at user device 110. User device 110 can use the authentication credentials to access the user account (e.g., user account data 132) and synchronize entitlement data 116 stored on user device 110 with entitlement data 134 associated with the user account stored on server device 130. Thus, user device 110 can obtain entitlement data from the server device and/or provide entitlement data to the server device for synchronization with other user devices associated with the same user.

In some implementations, user device 110 can include watch list application 114. For example, watch list application 114 can be a software application that presents media content item suggestions on a display of user device 110. Watch list application 114 can, for example, receive watched media data from each content provider application 112 installed on user device 110 indicating which media content items the user is watching (or has watched) in each content provider application. Watch list application 114 can collect the watched media data and entitlement data 116 and send the watched media data and entitlement data 116 to server device 140 so that server device 140 can generate media content item recommendations for the user.

In some implementations, user device 110 can include recommended content 118. For example, server device 140 can generate media content item recommendations based on the watched media data and the entitlement data 116. Server device 140 can send the media content item recommendations to user device 110 (e.g., and other user devices). User device 110 can store the media content item recommendations as recommended content 118. Recommended content 118 can include media content item metadata that describes a recommended media items (e.g., movie, television show, music track, etc.). The media content item metadata for each recommended (e.g., suggested) media item can include a title, author, actor, genre, or any of the other common media metadata items. However, since recommended content 118 includes media content item recommendations from across different content providers, recommended content 118 can include metadata for each media item that indicates which content providers provide the media content item and a content provider specific identifier (e.g., uniform resource locator ‘URL’) for the media content item for each content provider. Recommended content 118 can identify several content providers for a single suggested media item. Recommended content 118 can include a ranking of content providers determined by server device 130 based on a variety of criteria (e.g., media quality, amount of advertising, cost, etc.).

In some implementations, watch list application 114 can present representations of the media items identified in recommended content 118 on a display of user device 110. When a user selects a recommended media content item, watch list application 114 can provide the content provider specific identifier for the selected media item to a preferred content provider application 112 to cause content provider application 112 to obtain and present the identified content item on a display of user device 110, as described further below. For example, the preferred content provider application 112 can be determined based on the ranking of the content providers associated with the selected media content item.

In some implementations, the preferred content provider application 112 can correspond to the highest ranked content provider as identified by the data in recommended content 118. As described above, recommended or suggested content items are selected from content provided by content providers from whom the user is entitled to receive, view, and/or playback content. A user may be entitled to receive or view content from a content provider when the content provider provides free content. A user may be entitled to receive or view content from a content provider when the user has previously paid the content provider for a subscription that allows the user to receive or view content provided by the content provider. Since multiple content providers may provide access to a recommended content item, watch list server 136 can rank content providers associated with a recommended content item based on a variety of criteria. For example, content providers that provide content without commercials can be ranked higher than content providers that present commercials during playback of a media content item. Content providers that require the user authentication (e.g., require the user to provide input specifying a user name and password) when the corresponding content provider application is invoked can be ranked lower than content providers that do not require user input to authenticate the user with each invocation of the corresponding content provider application. Content providers that have larger media content item catalogues (e.g., media libraries, media databases, etc.) can be ranked higher than content providers that have smaller media content item catalogues. Content providers that provide for in-application purchases of content in the corresponding content provider applications can be ranked lower or higher than content providers that require a user to purchase additional content through means external to the corresponding content provider application. Other ranking criteria can also be used to determine a ranking for a content provider. For example, content providers that provide higher quality media content items can be ranked higher than content providers that provide lower quality media content items. Moreover, the above criteria can be combined in any combination to determine the relative rankings of each content provider identified for a suggested or recommended media content item.

In some implementations, system 100 can include server device(s) 130. For example, the features provided by and/or operations performed by server device 130 can be performed by a single server device 130 or distributed among multiple server devices 130. Server device(s) 130 can generate recommendations for media content items that a user may be interested in based on previously watched media items and/or entitlement data associated with the user. Server device(s) 130 may store software applications (e.g., content provider applications) that the user can install on the user's devices (e.g., user device 110, user device 160, etc.).

In some implementations, server device(s) 130 can include user account data 132. For example, user account data 132 can correspond to a cloud service account that the user has configured with a cloud service provided by server device(s) 130. User account data 132 can correspond to an application store account that the user has configured with application store server 140.

In some implementations, user account data 132 can include entitlement data 134. For example, the cloud service or application store server 140 can synchronize entitlement data 134 among multiple user devices associated with user account data 132. Entitlement data 134 can, therefore, correspond to entitlement data 116 on user device 110 and/or entitlement data 166 on user device 160. For example, when the user uses user device 110 to purchase a subscription to a new media content provider, user device 110 can send entitlement data 116, including a content provider identifier for the new media content provider, to server device(s) 130. Server device(s) 130 can update (e.g., through the cloud service, through application store server 140) entitlement data 134 to identify the new media content provider. Server device(s) 130 can then synchronize entitlement data 134 on server device(s) 130 with entitlement data 166 on user device 160 so that both user device 110 and user device 160 associated with the same user have the same entitlement data.

In some implementations, server device(s) 130 can include watch list server 136. For example, watch list server 136 can receive watched media item data from watch list application 114 on user device 110 and/or from watch list application 164 on user device 160. Watch list server 136 can generate content recommendations for the user of user device 110 and user device 160 based on the watched media item data and/or entitlement data 134. For example, watch list server 136 can generate media content recommendations based on media content items provided by content providers identified in entitlement data 134. Thus, the media content recommendations may only include media content items that are free, already included in a paid subscription, or require no additional payment by the user. Watch list server 136 can determine the user's media content preferences based on historical watched media data received from user device 110 and/or user device 160. For example, watch list server 136 can determine the user's preferences (e.g., genre, actors, directors, etc.) based on the watched media data and find similar media content items in universal content catalogue 138.

In some implementations, server device(s) 130 can include universal content catalogue 138. For example, universal content catalogue 138 can be a repository or database that identifies media items available from various content providers. Each media item entry in universal content catalogue 138 can include an identifier for a media item, metadata (e.g., genre, actors, directors, etc.) for the media item, content providers that provide the media item, and content provider specific identifiers (e.g., a URL) for the media item. For example, more than one content provider may be able to provide access to the media item so universal content catalogue can store information identifying each content provider from which the user can obtain the media item. When watch list server 136 generates content item recommendations or suggestions, watch list server 136 can rank the content providers for a media item according to various criteria (e.g., quality of media item, amount of advertising, etc.) and send the ranking along with the media item metadata to watch list application 114 (and/or watch list application 164), as described above.

In some implementations, server device(s) 130 can include application store server 140. For example, user device 110 and/or user device 160 can interact with application store server 140 to download content provider applications from application database 150 (e.g., a repository of applications) to user device 110 and/or user device 160, as described further below.

In some implementations, system 100 can include user device 160. For example, user device 160 can include similar features and/or functionality as user device 110. User device 160 and user device 110 may be owned or used by the same user and, therefore, may receive and/or store the same entitlement data 166/116 and/or recommended content 168/118. User device 160 may include watch list application 164 corresponding to watch list application 114. However, user device 160 may not include the all of the same content provider applications 112 as user device 110. For example, user device 160 may be missing (e.g., represented by dashed line) a content provider application 162 that is installed on user device 110. Thus, when watch list application 164 presents a content item recommendation, user device 160 may be missing the content provider application 162 needed to present the recommended content item.

In some implementations, user device 160 can include an application store application (not shown). For example, a user will typically interact with the application store application to download and install content provider application 162. However, switching between applications (e.g., from watch list application 164 to the application store application), searching for content provider application 162, and initiating the download of content provider application 162 can be burdensome and time consuming.

However, implementations described herein can improve the user experience (e.g., reduce the time and effort required to download the missing application) by automatically initiating the download of content provider application 162 when the user selects a recommended content item corresponding to the missing content provider application 162 from the watch list application 164. For example, when the user selects a content item recommended by watch list application 164, watch list application 164 can determine the highest ranked content provider for the selected content item, determine that the content provider application (e.g., content provider application 162) corresponding to the highest ranked content provider does not exist on user device 160, and download the missing content provider application from application store server 140 on server device(s) 130 through network 170, as described in greater detail below.

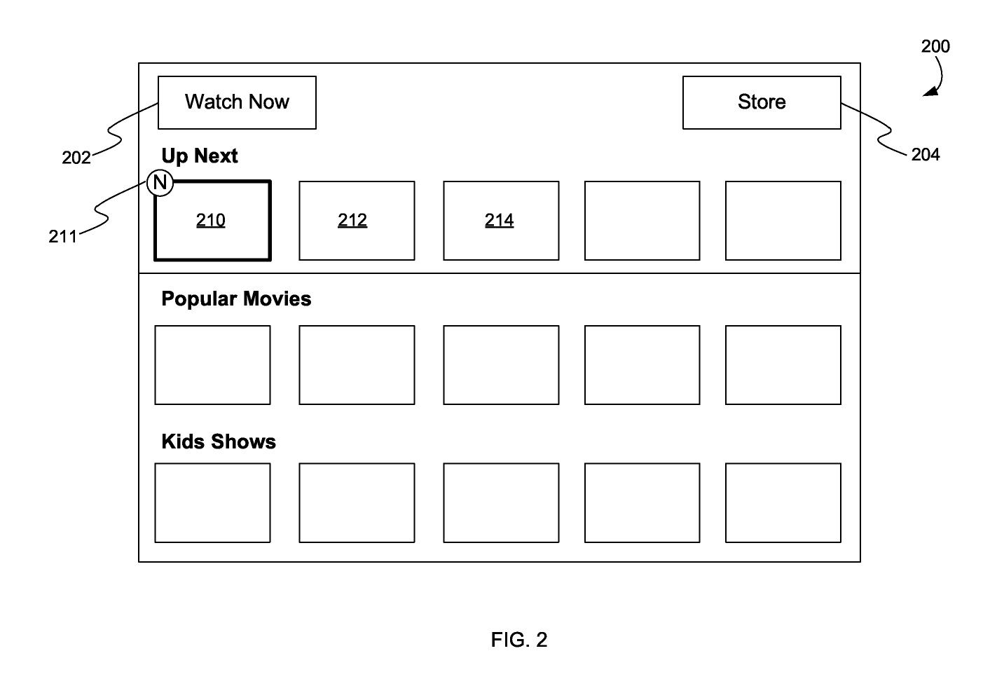

FIG. 2 illustrates an example graphical user interface 200 for presenting media content item recommendations. For example, graphical user interface (GUI) 200 can be a GUI presented by watch list application 164 on a display of user device 160. GUI 200 can present representations of various media content items provided by various media content providers. For example, the media content items represented on GUI 200 can correspond to media content items identified in recommended content 168 received from watch list server 136.

In some implementations, GUI 200 can include graphical element 202 for presenting recommended media content items on GUI 200. For example, a user can select graphical element 202 to cause watch list application 164 to present media items recommended by watch list server 136 based on historical watched media data collected from various user devices (e.g., user device 110, user device 160). As described above, the recommended media items can be media items that are free for the user to watch or media items from media content providers with whom the user has an active subscription. Thus, the media items presented on GUI 200 may only include media items that do not require an additional payment from the user. If the user of user device 160 should wish to purchase additional content, the user can select graphical element 204 to view various media items that are available for purchase.

In some implementations, GUI 200 can present representations of content items available from various content providers. For example, GUI 200 can include graphical element 210 representing a recommended media item. Graphical element 210 can represent a recommended media item available from content provider “NetMovies” and content provider “TVPrime.” For example, the content providers for the media item corresponding to graphical element 210 can be identified in the corresponding media item metadata stored in recommended content 168. As described above, only content providers with whom the user already has a subscription or entitlement will be presented on GUI 200. In some implementations, graphical element 210 can include an indication 211 of the preferred (e.g., highest ranked) media content provider for the corresponding media item. In the example of FIG. 2, the preferred media content provider for the media item represented by graphical element 210 is “NetMovies.”

Similarly, GUI 200 can include graphical element 212 representing a corresponding recommended media item provided by content provider “ClassicFlix.” GUI 200 can include graphical element 214 representing a corresponding recommended media item provided by content providers “OldMedia” and “NetMovies,” where “OldMedia” is the preferred content provider.

In some implementations, GUI 200 can receive a user selection of graphical element 210. When GUI 200 receives the user selection, watch list application 164 can determine whether the content provider application for the preferred content provider associated with the selected media item is installed on user device 160. As described above, user device 160 may receive a media item suggestion for a media item provided by a content provider (e.g., “NetMovies”) whose content provider application 162 is not installed on user device 160. For example, watch list server 136 may generate the media item recommendation based on entitlement data and watched media data received from other user devices (e.g., user device 110) where the “NetMovies” content provider application is installed and where the user has viewed content using the “NetMovies” content provider application. Thus, even though user device 160 is missing the preferred content provider application, watch list application 164 can present graphical element 210 representing a media content item provided by the missing content provider application on GUI 200.

In some implementations, watch list application 164 can initiate a download of a missing content provider application. For example, when watch list application 164 determines that the preferred content provider application is missing on user device 160, watch list application 164 can automatically initiate a download of the missing content provider application (e.g., content provider application 162) from application store server 140 on server device(s) 130. For example, rather than requiring that the user navigate to another application (e.g., an application store application), search for the missing content provider application, and initiate the download of the content provider application, watch list application 164 can automatically initiate the download of the missing content provider application from within watch list application 164. For example, watch list application 164 can use the content provider identifier in the media item metadata corresponding to graphical element 210 to request the corresponding content provider application from application store server 140. Thus, the user does not have to exit watch list application 164 to download the missing content provider application.

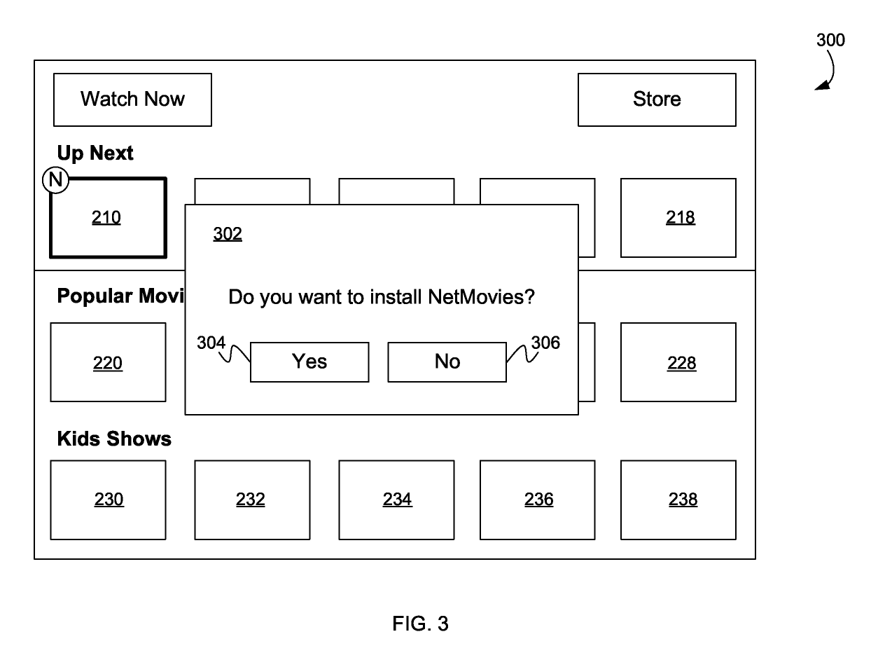

FIG. 3 illustrates an example graphical user interface 300 for prompting the user to install a missing content provider application. For example, GUI 300 can correspond to GUI 200 of FIG. 2. GUI 300 can be presented by watch list application 164 in response to the user selecting graphical element 210 corresponding to a recommended media item having a preferred content provider whose content provider application is not installed on user device 160.

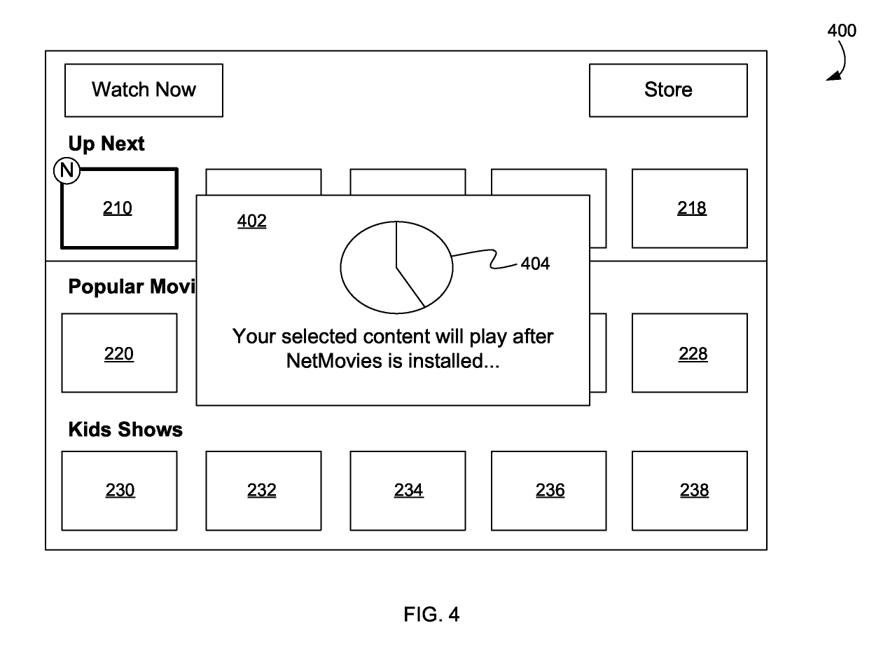

In some implementations, GUI 300 can include graphical element 302 prompting the user to install the missing content provider application. For example, graphical element 302 can include graphical element 304 that when selected by the user causes watch list application 164 to download the missing content provider application from application store server 140. For example, when the content provider application for the content provider “NetMovies” is missing on user device 160, watch list application 164 can send a request to application store server 140 that includes an identifier for the content provider “NetMovies.” Application store server 140 can obtain the content provider application for the content provider “NetMovies” from application database 150 and send the content provider application (e.g., content provider application 162) to user device 160 so that the content provider application can be installed on user device 160. When watch list application 164 begins downloading the missing content provider application, watch list application 164 can present GUI 400 of FIG. 4.

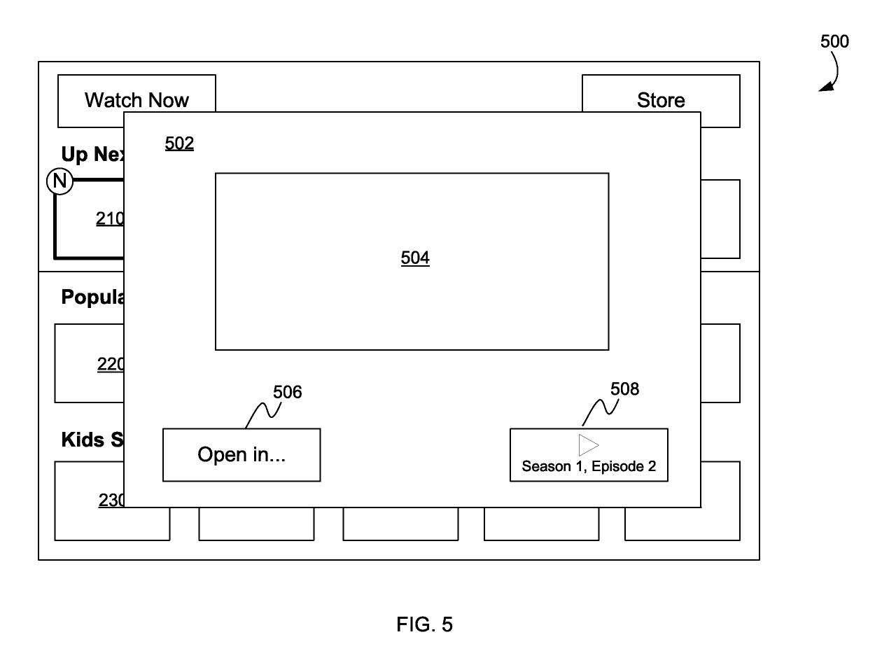

In some implementations, graphical element 302 can include graphical element 306. For example, the user can select graphical element 306 when the user does not wish to install the missing content provider application on user device 160. In response to receiving the selection of graphical element 306, watch list application 164 can present GUI 500 of FIG. 5.

FIG. 4 illustrates an example graphical user interface 400 for presenting the status of a content provider application download process. For example, watch list application 164 can present GUI 400 of FIG. 4 after watch list application 164 begins downloading the missing content provider application in response to the user selecting graphical element 304.

In some implementations, GUI 400 can include graphical element 402 for presenting content provider application download state information. For example, graphical element 402 can present a message informing the user that the selected recommended media item will be presented after the preferred content provider application is installed on user device 160. Graphical element 402 can include an animated graphical element 404 indicating a proportion of the preferred content provider application that has been installed or downloaded at different times during the download. After the download has finished, watch list application 164 can invoke the downloaded content provider application and provide the content provider specific identifier (e.g., URL) for the selected media content item to the content provider application so that the content provider application can begin playback of the selected media content item.

FIG. 5 illustrates an example graphical user interface 500 presenting options for selecting a media content provider application. For example, GUI 500 can be presented by watch list application 164 in response to the user selecting graphical element 306 of GUI 300.

In some implementations, GUI 500 can include graphical element 502. For example, graphical element 502 can be a window, popup, overlay, or some other graphical element. Graphical element 502 can include image 504 representing the recommended media content item represented by graphical element 210 selected by the user.

Graphical element 502 can include graphical element 506 (e.g., a button) for viewing other media content provider applications that can playback the selected media item. The user can select graphical element 506 to cause watch list application 164 to present content provider applications that can playback the selected media content item. For example, in response to receiving the user selection of graphical element 506, watch list application can present a list of media content provider applications corresponding to the media content providers identified in the metadata for the recommended media content item represented by graphical element 210. The user can then select a media content provider application from the list to initiate playback of the selected media content item in the selected media content provider application.

Graphical element 502 can include graphical element 508 (e.g., a button) for selecting the preferred media content provider application for playing back the media item (e.g., selected media item) corresponding to selected graphical element 210. For example, in response to receiving the user selection of graphical element 508, watch list application 164 can present GUI 300 of FIG. 3.

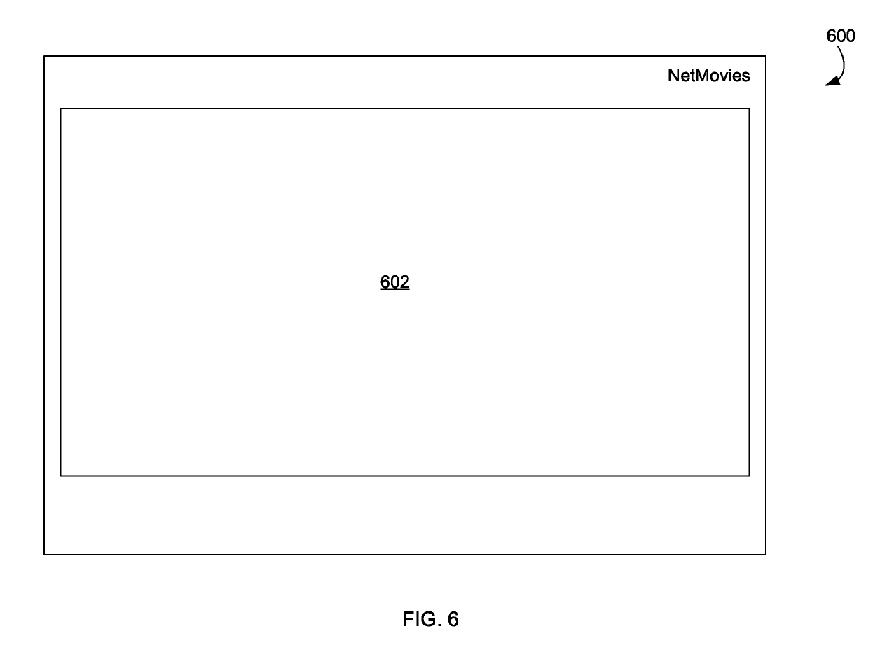

FIG. 6 illustrates an example graphical user interface 600 of a content provider application. For example, after watch list application 164 downloads the preferred content provider application in response to the user selecting graphical element 210, watch list application can invoke the downloaded content provider application and provide the content provider identifier (e.g., URL) for the corresponding media item to the content provider application. The content provider application (e.g., content provider application 162 can then present the media item in GUI 600. For example, content provider application 162 can obtain the selected media item from the content provider server corresponding to content provider application 162 and present the media item in media item control 602.

In some implementations, content provider application 162 can request login credentials from the user. For example, to prove that the user is entitled to view media content items in content provider application 162, the user may need to login to the corresponding content provider server (e.g., service). Content provider application 162 may present additional graphical user interfaces and/or graphical elements to obtain the user's login credentials for the corresponding content provider from the user.

In some implementations, watch list graphical user interface 200 may be presented when the selected media item is terminated in content provider application 162. For example, in response to the media item completing playback and/or in response to the user exiting playback of the media item in content provider application 162, wait list application 164 can present GUI 200. For example, since content provider application 162 sends watched media data indicating the state of media items presented by content provider application 162, as described above, watch list application 164 can detect when playback of the selected media item is terminated (e.g., concluded, exited, etc.). when watch list application 164 detects that playback of the selected media item has terminated, watch list application 164 can present GUI 200 on the display of user device 160 so that the user can select another recommended media item from GUI 200.

### Example Process

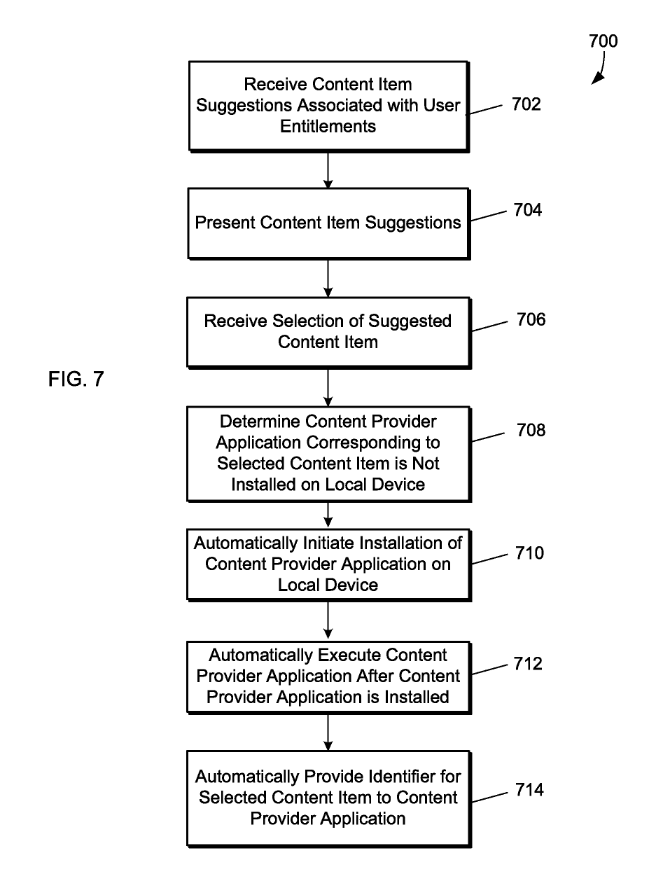

FIG. 7 is flow diagram of an example process 700 for automatically installing content provider applications based on content selection. For example, process 700 can be performed by watch list application 164, or watch list application 114, to download and install a content provider application for a recommended media content item selected by a user. While process 700 is described as a particular sequence of steps performed by user device 160, the steps of process 700 may be rearranged and/or performed in a different order while still producing the same result. Similarly, some steps of process 700 may be omitted while producing the same result.

At step 702, user device 160 can receive content item suggestions associated with user entitlements. For example, watch list server 126 can generate media content item suggestions (e.g., recommended content 168) based on media content items provided by content providers with whom the user of user device 160 has a subscription or from whom the user is otherwise entitled to view media content. The media content item suggestions can be based on media content items previously watched by the user on any of the user's devices (e.g., user device 110, user device 160, etc.). The content item suggestions (e.g., recommended content 168) can identify media content items and provide metadata for each recommended media content item. The metadata can include identifiers for each content provider from which the user is entitled to obtain media content items without additional charge. The content providers can be ranked and the metadata can identify a preferred content provider for the corresponding media content item. Watch list server 126 can send the content item suggestions (e.g., recommended content 168) to watch list application 164 on user device 160.

At step 704, user device 160 can present media content item suggestions on a display of user device 160. For example, watch list application 164 can present graphical elements representing each of the recommended media content items received from watch list server 126, as described above with reference to FIG. 2.

At step 706, user device 160 can receive a selection of a suggested media content item. For example, watch list application 164 can receive a selection of a representation of a recommended media content item presented on GUI 200 of FIG. 2.

At step 708, user device 160 can determine that the preferred content provider application corresponding to the selected media content item is not installed on user device 160. For example, watch list application 164 can search an application registry on user device 160 to determine that a content provider application associated with the preferred content provider for the selected media content item is missing from user device 160.

At step 710, user device 160 can automatically initiate installation of the missing content provider application on user device 160. For example, watch list application 164 can download the content provider application from application server 140 and/or install the content provider application on user device 160.

At step 712, user device 160 can automatically execute the content provider application after the content provider application is installed on user device 160. For example, watch list application 164 can detect that the download process has completed for the content provider application. In response to detecting that the download has completed, watch list application 164 can invoke the content provider application on user device 160.

At step 714, user device 160 can automatically provide an identifier for the selected content item to the invoked content provider application. For example, watch list application 164 can provide a content provider specific URL that identifies the selected media content item to the content provider application and/or corresponding content provider server. For example, the URL can be obtained from metadata corresponding to the selected media content item received from watch list server 136 in recommended content 168. Thus, the content provider application can automatically obtain and begin playback of the selected media content item.

### Graphical User Interfaces

This disclosure above describes various Graphical User Interfaces (GUIs) for implementing various features, processes or workflows. These GUIs can be presented on a variety of electronic devices including but not limited to laptop computers, desktop computers, computer terminals, television systems, tablet computers, e-book readers and smart phones. One or more of these electronic devices can include a touch-sensitive surface. The touch-sensitive surface can process multiple simultaneous points of input, including processing data related to the pressure, degree or position of each point of input. Such processing can facilitate gestures with multiple fingers, including pinching and swiping.

When the disclosure refers to “select” or “selecting” user interface elements in a GUI, these terms are understood to include clicking or “hovering” with a mouse or other input device over a user interface element, or touching, tapping or gesturing with one or more fingers or stylus on a user interface element. User interface elements can be virtual buttons, menus, selectors, switches, sliders, scrubbers, knobs, thumbnails, links, icons, radio buttons, checkboxes and any other mechanism for receiving input from, or providing feedback to a user.

### Privacy

The present disclosure recognizes that the use of such personal information data, in the present technology, can be used to the benefit of users. For example, the personal information data can be used to deliver targeted content that is of greater interest to the user. Accordingly, use of such personal information data enables calculated control of the delivered content. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services. In another example, users can select not to provide location information for targeted content delivery services. In yet another example, users can select to not provide precise location information, but permit the transfer of location zone information.

### Example System Architecture

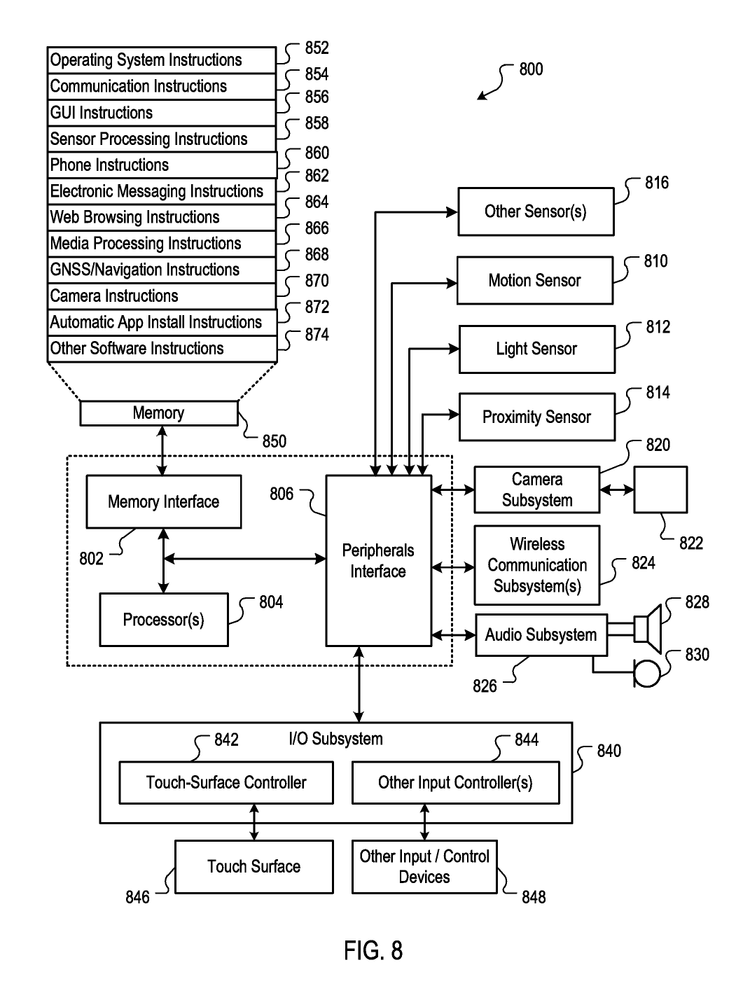

FIG. 8 is a block diagram of an example computing device 800 that can implement the features and processes of FIGS. 1-7. The computing device 800 can include a memory interface 802, one or more data processors, image processors and/or central processing units 804, and a peripherals interface 806. The memory interface 802, the one or more processors 804 and/or the peripherals interface 806 can be separate components or can be integrated in one or more integrated circuits. The various components in the computing device 800 can be coupled by one or more communication buses or signal lines.

Sensors, devices, and subsystems can be coupled to the peripherals interface 806 to facilitate multiple functionalities. For example, a motion sensor 810, a light sensor 812, and a proximity sensor 814 can be coupled to the peripherals interface 806 to facilitate orientation, lighting, and proximity functions. Other sensors 816 can also be connected to the peripherals interface 806, such as a global navigation satellite system (GNSS) (e.g., GPS receiver), a temperature sensor, a biometric sensor, magnetometer or other sensing device, to facilitate related functionalities.

A camera subsystem 820 and an optical sensor 822, e.g., a charged coupled device (CCD) or a complementary metal-oxide semiconductor (CMOS) optical sensor, can be utilized to facilitate camera functions, such as recording photographs and video clips. The camera subsystem 820 and the optical sensor 822 can be used to collect images of a user to be used during authentication of a user, e.g., by performing facial recognition analysis.

Communication functions can be facilitated through one or more wireless communication subsystems 824, which can include radio frequency receivers and transmitters and/or optical (e.g., infrared) receivers and transmitters. The specific design and implementation of the communication subsystem 824 can depend on the communication network(s) over which the computing device 800 is intended to operate. For example, the computing device 800 can include communication subsystems 824 designed to operate over a GSM network, a GPRS network, an EDGE network, a Wi-Fi or WiMax network, and a Bluetooth™ network. In particular, the wireless communication subsystems 824 can include hosting protocols such that the device 100 can be configured as a base station for other wireless devices.

An audio subsystem 826 can be coupled to a speaker 828 and a microphone 830 to facilitate voice-enabled functions, such as speaker recognition, voice replication, digital recording, and telephony functions. The audio subsystem 826 can be configured to facilitate processing voice commands, voiceprinting and voice authentication, for example.

The I/O subsystem 840 can include a touch-surface controller 842 and/or other input controller(s) 844. The touch-surface controller 842 can be coupled to a touch surface 846. The touch surface 846 and touch-surface controller 842 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch surface 846.

The other input controller(s) 844 can be coupled to other input/control devices 848, such as one or more buttons, rocker switches, thumb-wheel, infrared port, USB port, and/or a pointer device such as a stylus. The one or more buttons (not shown) can include an up/down button for volume control of the speaker 828 and/or the microphone 830.

In one implementation, a pressing of the button for a first duration can disengage a lock of the touch surface 846; and a pressing of the button for a second duration that is longer than the first duration can turn power to the computing device 800 on or off. Pressing the button for a third duration can activate a voice control, or voice command, module that enables the user to speak commands into the microphone 830 to cause the device to execute the spoken command. The user can customize a functionality of one or more of the buttons. The touch surface 846 can, for example, also be used to implement virtual or soft buttons and/or a keyboard.

In some implementations, the computing device 800 can present recorded audio and/or video files, such as MP3, AAC, and MPEG files. In some implementations, the computing device 800 can include the functionality of an MP3 player, such as an iPod™. The computing device 800 can, therefore, include a 36-pin connector that is compatible with the iPod. Other input/output and control devices can also be used.

The memory interface 802 can be coupled to memory 850. The memory 850 can include high-speed random access memory and/or non-volatile memory, such as one or more magnetic disk storage devices, one or more optical storage devices, and/or flash memory (e.g., NAND, NOR). The memory 850 can store an operating system 852, such as Darwin, RTXC, LINUX, UNIX, OS X, WINDOWS, or an embedded operating system such as VxWorks.

The operating system 852 can include instructions for handling basic system services and for performing hardware dependent tasks. In some implementations, the operating system 852 can be a kernel (e.g., UNIX kernel). In some implementations, the operating system 852 can include instructions for performing voice authentication. For example, operating system 852 can implement the automatic application installation features as described with reference to FIGS. 1-7.

The memory 850 can also store communication instructions 854 to facilitate communicating with one or more additional devices, one or more computers and/or one or more servers. The memory 850 can include graphical user interface instructions 856 to facilitate graphic user interface processing; sensor processing instructions 858 to facilitate sensor-related processing and functions; phone instructions 860 to facilitate phone-related processes and functions; electronic messaging instructions 862 to facilitate electronic-messaging related processes and functions; web browsing instructions 864 to facilitate web browsing-related processes and functions; media processing instructions 866 to facilitate media processing-related processes and functions; GNSS/Navigation instructions 868 to facilitate GNSS and navigation-related processes and instructions; and/or camera instructions 870 to facilitate camera-related processes and functions.

The memory 850 can store other software instructions 872 to facilitate other processes and functions, such as the automatic application installation processes and functions as described with reference to FIGS. 1-7.

The memory 850 can also store other software instructions 874, such as web video instructions to facilitate web video-related processes and functions; and/or web shopping instructions to facilitate web shopping-related processes and functions. In some implementations, the media processing instructions 866 are divided into audio processing instructions and video processing instructions to facilitate audio processing-related processes and functions and video processing-related processes and functions, respectively.

Each of the above identified instructions and applications can correspond to a set of instructions for performing one or more functions described above. These instructions need not be implemented as separate software programs, procedures, or modules. The memory 850 can include additional instructions or fewer instructions. Furthermore, various functions of the computing device 800 can be implemented in hardware and/or in software, including in one or more signal processing and/or application specific integrated circuits.

What is claimed is:

1. A method comprising:
receiving, by a computing device, content item suggestions associated with user entitlements;
presenting, by a first application running on the computing device, the received content item suggestions on a display of the computing device;
receiving, by the first application running on the computing device, a selection of a suggested content item;
determining, by the first application running on the computing device, a preferred content provider for the selected content item;
determining, by the first application running on the computing device, that a content provider application corresponding to the preferred content provider is missing from the computing device; and
automatically initiating, by the first application running on the computing device, installation of the missing content provider application on the computing device.

2. The method of claim 1, further comprising:
automatically executing, by the first application running on the computing device, the content provider application after the content provider application is installed on the computing device; and
automatically providing, by the first application running on the computing device, a content provider specific identifier for the selected content item to the content provider application.

3. The method of claim 1, further comprising:
detecting, by the first application running on the computing device, that playback of the selected content item by the content provider application has terminated; and
in response to the detecting, presenting, by the first application running on the computing device, a graphical user interface of the first application, the graphical user interface presenting the received content item suggestions on a display of the computing device.

4. The method of claim 1, wherein the content item suggestions include identifiers for a plurality of content providers from which a user of the computing device is entitled to obtain media content items.

5. The method of claim 4, wherein the content item suggestions include content provider specific identifiers for the selected content item for each of the plurality of content providers.

6. The method of claim 2, further comprising:
automatically initiating playback of the selected content item using the content provide application installed on the computing device.

7. The method of claim 1, wherein the user entitlements include information identifying subscriptions that the user has obtained to access content provided by one or more one or more content providers.

8. A non-transitory computer readable medium including one or more sequences of instructions that, when executed by one or more processors, cause the processors to perform operations comprising:
receiving, by a computing device, content item suggestions associated with user entitlements;
presenting, by a first application running on the computing device, the received content item suggestions on a display of the computing device;
receiving, by the first application running on the computing device, a selection of a suggested content item;
determining, by the first application running on the computing device, a preferred content provider for the selected content item;
determining, by the first application running on the computing device, that a content provider application corresponding to the preferred content provider is missing from the computing device; and
automatically initiating, by the first application running on the computing device, installation of the missing content provider application on the computing device.

9. The non-transitory computer readable medium of claim 8, wherein the instructions cause the processors to perform operations comprising:
automatically executing, by the first application running on the computing device, the content provider application after the content provider application is installed on the computing device; and
automatically providing, by the first application running on the computing device, a content provider specific identifier for the selected content item to the content provider application.

10. The non-transitory computer readable medium of claim 8, wherein the instructions cause the processors to perform operations comprising:
detecting, by the first application running on the computing device, that playback of the selected content item by the content provider application has terminated; and
in response to the detecting, presenting, by the first application running on the computing device, a graphical user interface of the first application, the graphical user interface presenting the received content item suggestions on a display of the computing device.

11. The non-transitory computer readable medium of claim 8, wherein the content item suggestions include identifiers for a plurality of content providers from which a user of the computing device is entitled to obtain media content items.

12. The non-transitory computer readable medium of claim 11, wherein the content item suggestions include content provider specific identifiers for the selected content item for each of the plurality of content providers.

13. The non-transitory computer readable medium of claim 9, wherein the instructions cause the processors to perform operations comprising:
automatically initiating playback of the selected content item using the content provide application installed on the computing device.

14. The non-transitory computer readable medium of claim 8, wherein the user entitlements include information identifying subscriptions that the user has obtained to access content provided by one or more one or more content providers.

15. A computing device comprising:
one or more processors; and
a non-transitory computer readable medium including one or more sequences of instructions that, when executed by the one or more processors, cause the processors to perform operations comprising:
receiving, by the computing device, content item suggestions associated with user entitlements;
presenting, by a first application running on the computing device, the received content item suggestions on a display of the computing device;
receiving, by the first application running on the computing device, a selection of a suggested content item;
determining, by the first application running on the computing device, a preferred content provider for the selected content item;
determining, by the first application running on the computing device, that a content provider application corresponding to the preferred content provider is missing from the computing device; and
automatically initiating, by the first application running on the computing device, installation of the missing content provider application on the computing device.

16. The computing device of claim 15, wherein the instructions cause the processors to perform operations comprising:
automatically executing, by the first application running on the computing device, the content provider application after the content provider application is installed on the computing device; and
automatically providing, by the first application running on the computing device, a content provider specific identifier for the selected content item to the content provider application.

17. The computing device of claim 15, wherein the instructions cause the processors to perform operations comprising:
detecting, by the first application running on the computing device, that playback of the selected content item by the content provider application has terminated; and
in response to the detecting, presenting, by the first application running on the computing device, a graphical user interface of the first application, the graphical user interface presenting the received content item suggestions on a display of the computing device.

18. The computing device of claim 15, wherein the content item suggestions include identifiers for a plurality of content providers from which a user of the computing device is entitled to obtain media content items.

19. The computing device of claim 18, wherein the content item suggestions include content provider specific identifiers for the selected content item for each of the plurality of content providers.

20. The computing device of claim 16, wherein the instructions cause the processors to perform operations comprising:
automatically initiating playback of the selected content item using the content provide application installed on the computing device.

21. The computing device of claim 15, wherein the user entitlements include information identifying subscriptions that the user has obtained to access content provided by one or more one or more content providers.
